(19) United States
(12) Patent Application Publication
(10) Pub. No.: US 2015/0268970 A1
(43) Pub. Date: Sep. 24, 2015

(54) SELECTIVELY ENABLING PLATFORM-SPECIFIC FEATURES

(71) Applicants: Giri P. Mudusuru, Portland, OR (US); Krishna Kumar Ganesan, Hillsboro, OR (US); Nicholas J. Adams, Beaverton, OR (US); Sandeep R. Nair, Hillsboro, OR (US)

(72) Inventors: Giri P. Mudusuru, Portland, OR (US); Krishna Kumar Ganesan, Hillsboro, OR (US); Nicholas J. Adams, Beaverton, OR (US); Sandeep R. Nair, Hillsboro, OR (US)

(21) Appl. No.: 14/221,983

(22) Filed: Mar. 21, 2014

(51) Int. Cl. G06F 9/44

(52) U.S. Cl. CPC G06F 9/4411

(57) ABSTRACT

Technologies for selectively enabling platform-specific features includes a computing device that initializes virtual device driver logic to interface with a virtual device of an Advanced Configuration and Power Interface (ACPI) subsystem. The ACPI subsystem includes an operating system (OS)-specific function specification associated with the virtual device. The OS-specific function specification includes OS-specific functions to be performed by the ACPI subsystem based on an identified OS. The virtual device driver logic transmits a call to the OS-specific function specification in the ACPI subsystem. The call includes an identifier of an OS of the computing device that uniquely identifies the OS from other operating systems. The ACPI subsystem analyzes the OS-specific function specification to determine OS-specific functions associated with the OS based on the identifier. The ACPI subsystem performs the determined OS-specific functions.

### BACKGROUND

Computing devices generally include an operating system, which manages the various hardware and software resources of the computing device. During the booting process, modern operating systems often rely on firmware provided by hardware vendors to expose the hardware devices and/or features of the computing device available to the operating system. Oftentimes, certain hardware devices and/or features may be operating system-specific. That is, a particular hardware device and/or feature may be compatible for use with one operating system but not another. As such, in an effort to decrease distribution and maintenance costs, hardware vendors typically release a single piece of firmware across a product line that supports multiple operating systems. It is therefore important that the firmware know what operating system is being booted to ensure that only compatible hardware devices and/or features are exposed to the operating system.

As the market for portable computing devices heats up, competition among operating system vendors is increasing. This competition is driving operating system vendors to develop and release new features to market faster than before. Many of these new features do not follow industry standards, yet they rely on platform and/or operating-specific hardware devices and/or features provided by the firmware. Such practice increases the risk of incompatible hardware devices and/or features being exposed to the operating system during boot. Such practice also threatens the ability of hardware vendors to release one piece of firmware across a product line.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for using a computing device to selectively enable platform-specific features;

FIG. 2 is a simplified block diagram of at least one embodiment of an environment of the computing device of the system of FIG. 1;

FIG. 3 is a simplified flow diagram of at least one embodiment of a method for selectively enabling platform-specific features that may be executed by the computing device of FIGS. 1 and 2;

FIG. 4 is a simplified activity flow diagram of at least one embodiment of the method of FIG. 3 for selectively enabling platform-specific features;

FIG. 5 is an illustrative embodiment of an operating system (OS)-specific function specification that may be used by the computing device of FIGS. 1 and 2 for selectively enabling platform-specific features;

FIG. 6 is an illustrative embodiment of a function specification that may be used by the computing device of FIGS. 1 and 2 for selectively enabling platform-specific features;

FIG. 7 is an illustrative diagram of the resultant configuration of the computing device of FIGS. 1 and 2 in response to execution of the methods of FIGS. 3 and 9;

FIG. 8 is another illustrative diagram of the resultant configuration of the computing device of FIGS. 1 and 2 in response to execution of the methods of FIGS. 3 and 9;

FIG. 9 is a simplified flow diagram of at least one other embodiment of a method for selectively enabling platform-specific features that may be executed by the computing device of FIGS. 1 and 2; and

FIG. 10 is a simplified activity flow diagram of at least one embodiment of the method of FIG. 9 for selectively enabling platform-specific features.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

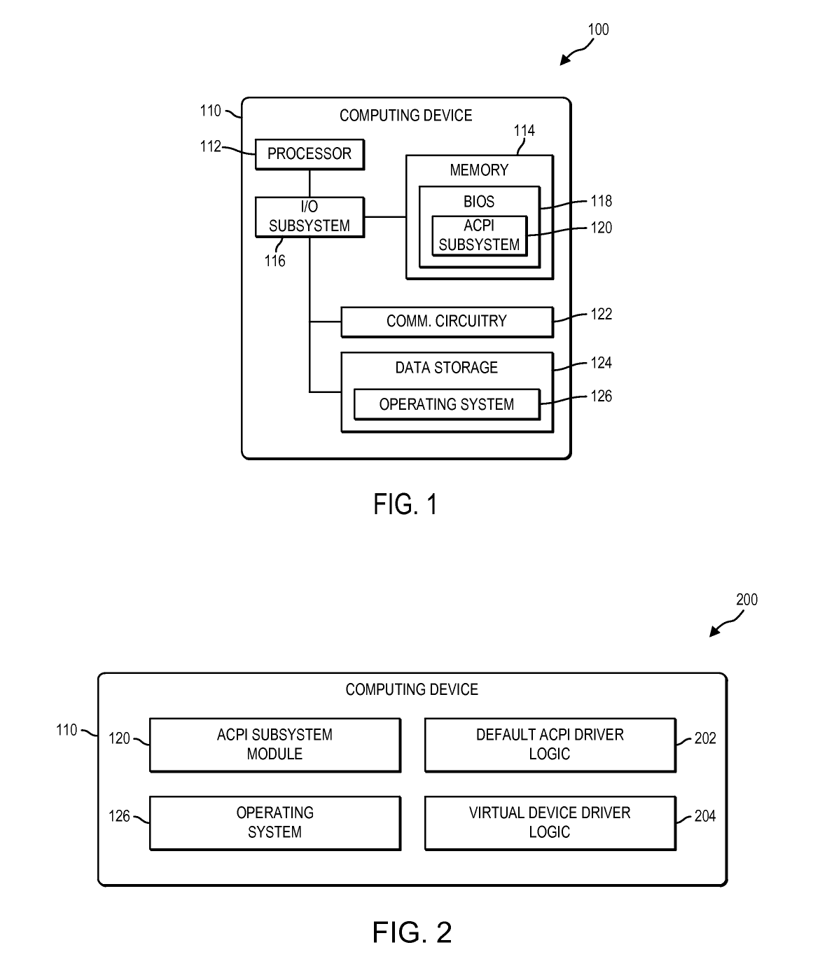

Referring now to FIG. 1, in an illustrative embodiment, a system 100 for selectively enabling platform-specific features includes a computing device 110. In use, the computing device 110 performs one or more operating system (OS)-specific functions during initialization of an OS 126. To do so, a basic input/output system (BIOS) interface 118 of the computing device 110 provides an Advanced Configuration and Power Interface (ACPI) subsystem 120 through which the computing device 110 may communicate and/or interact with the OS being initialized (e.g., booted, loaded, executed, etc.). To facilitate performing the OS-specific function(s) during initialization of the OS 126, the ACPI subsystem 120 includes a virtual ACPI device (e.g., a virtual ACPI object) and an OS-specific function specification (e.g., a device specific method or “_DSM”) associated with the virtual ACPI device. In some embodiments, the OS-specific function specification associated with the virtual ACPI device includes one or more OS-specific functions for various different operating systems (OSs). In such embodiments, a virtual device driver may be initialized by the OS 126 during the boot/initialization process to enable the OS 126 to interact with the virtual ACPI device. The virtual device driver may include a unique identifier (e.g., a Globally Unique IDentifier or “GUID,” a Universally Unique IDentifier or “UUID,” etc.) that uniquely identifies which OS 126 the virtual device driver is configured to interact with. In some embodiments, the virtual device driver may call the OS-specific function specification associated with the virtual ACPI device in the ACPI subsystem 120. The call may include the unique identifier of the OS 126 being initialized. Upon receiving the call, the ACPI subsystem 120 analyzes the OS-specific function specification to determine the one or more OS-specific functions that should be performed for the particular OS 126 being initialized based on the unique identifier. The ACPI subsystem 120 then performs the determined OS-specific function(s), which may include, for example, exposing one or more OS-specific platform features and/or OS-specific platform objects to the OS 126, enabling (e.g., adding features and/or objects to an ACPI namespace, loading, etc.) one or more OS-specific platform features and/or OS-specific platform objects for the OS 126, hiding (e.g., preventing exposure) one or more OS-specific platform features and/or OS-specific platform objects from the OS 126, and/or disabling (e.g., removing features and/or objects from the ACPI namespace, unloading, etc.) one or more OS-specific platform features and/or OS-specific platform objects for the OS 126. In that way, the computing device 110, via the ACPI subsystem 120, the virtual ACPI device, and the virtual device driver may be used to selectively enable and/or disable platform features and objects based on the particular OS 126 being initialized.

The computing device 110 may be embodied as, or otherwise include, any type of computing device capable of performing the functions described herein including, but not limited to a desktop computer, a laptop computing device, a server computer, a consumer electronic device, a mobile computing device, a mobile phone, a smart phone, a tablet computing device, a personal digital assistant, a wearable computing device, a smart television, a smart appliance, and/or other type of computing device. The illustrative computing device 110 includes a processor 112, a memory 114, an input/output (I/O) subsystem 116, a basic input/output system (BIOS) interface 118, communication circuitry 122, and a data storage 124. Of course, the computing device 110 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 114, or portions thereof, may be incorporated in the processor 112 in some embodiments.

The processor 112 may be embodied as any type of processor capable of performing the functions described herein. For example, the processor 112 may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the computing device 110 such as operating systems, applications, programs, libraries, and drivers. The memory 114 is communicatively coupled to the processor 112 via the I/O subsystem 116, which may be embodied as circuitry and/or components to facilitate input/output operations with the processor 112, the memory 114, and other components of the computing device 110. For example, the I/O subsystem 116 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 116 may form a portion of a system-on-a-chip (SoC) and be incorporated, along with the processor 112, the memory 114, and other components of the computing device 110, on a single integrated circuit chip.

The BIOS 118 may be embodied as hardware components, software components, or a combination thereof (e.g., system firmware, system initialization data, etc.) to facilitate booting or otherwise initializing a platform and/or operating system (OS) of the computing device 110. For example, the BIOS 118 may initialize and/or test various components of the computing device 110 (e.g., input/output devices). In some embodiments, the BIOS 118 may communicate and interact with an OS 126 being loaded via an Advanced Configuration and Power Interface (ACPI) subsystem 120 and/or framework, which may be provided by the BIOS 118. Additionally, as discussed below, the ACPI subsystem 120 may be configured to provide one or more OS-specific features to the OS 126 being loaded.

The communication circuitry 122 of the computing device 110 may be embodied as any type of communication circuit, device, or collection thereof, capable of enabling communications between the computing device 110 and one or more other computing devices. The communication circuitry 122 may be configured to use any one or more communication technologies (e.g., wireless or wired communications) and associated protocols (e.g., Ethernet, Wi-Fi®, WiMAX, etc.) to effect such communication.

The data storage 124 may be embodied as any type of device or devices configured for short-term or long-term storage of data such as, for example, memory devices and circuits, memory cards, hard disk drives, solid-state drives, or other data storage devices. For example, the data storage 124 may be configured to store one or more operating systems (e.g., the operating system 126 shown in FIG. 2) to be initialized and/or executed by the computing device 110. In some embodiments, portions of the operating system(s) may be copied to the memory 114 during operations for faster processing and/or any other reason.

Referring now to FIG. 2, in use, the computing device 110 establishes an environment 200 during operation. The illustrative environment 200 includes an ACPI subsystem module 120, the operating system (OS) 126, default ACPI driver logic 202, and virtual device driver logic 204. Each of the modules, logic, and other components of the environment 200 may be embodied as hardware, software, firmware, or a combination thereof. It should be appreciated that the computing device 110 may include other components, sub-components, modules, and devices commonly found in a computing device, which are not illustrated in FIG. 2 for clarity of the description.

The ACPI subsystem module 120 may be configured to interact and/or communicate with the operating system 126 being initialized (e.g., booted, loaded, executed, etc.) on the computing device 110. To do so, the ACPI subsystem module 120 may communicate with the default ACPI driver logic 202. As discussed below, in some embodiments, the default ACPI driver logic 202 may be initialized by the OS 126 prior to initialization of other drivers (e.g., the virtual device driver logic 204, video device driver logic, input/output driver logic, etc.). In such embodiments, ACPI subsystem module 120 may interact with the OS 126 prior to initialization of one or more other components and/or features of the computing device 110.

In some embodiments, the ACPI subsystem module 120 may be configured to load device data and/or object data corresponding to a virtual ACPI device and an associated OS-specific function specification into one or more ACPI tables. The virtual ACPI device may be embodied as a virtual ACPI object or any type of ACPI component that may be enumerated by the OS 126 during the booting process. The OS-specific function specification associated with the virtual ACPI device may be embodied as a device specific method or “_DSM.” It should be appreciated, however, that the OS-specific function specification may be embodied as any other type of ACPI control method (e.g., a custom control method, etc.), object, or any other type of ACPI component configured to perform the functions described herein. In some embodiments, the virtual ACPI device and the OS-specific function specification may be declared in an ACPI namespace to facilitate later enumeration of those devices/objects by the OS 126.

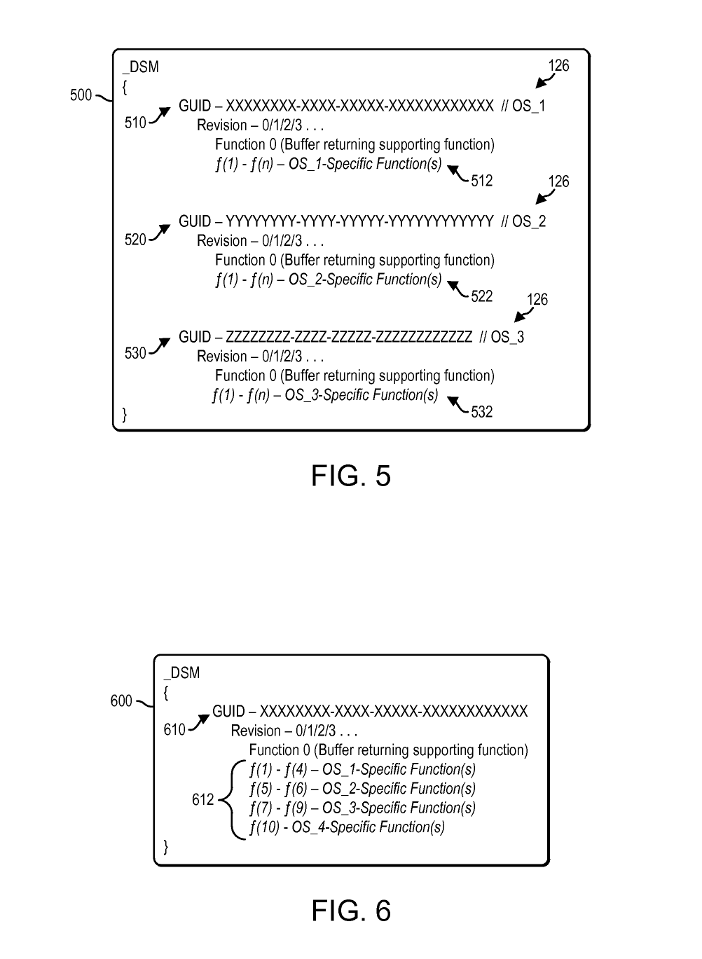

In some embodiments, the ACPI subsystem module 120 may also be configured to perform one or more functions based on the specific OS 126 being initialized (e.g., loaded, booted, executed, etc.). In such embodiments, the OS-specific function specification (e.g., the “_DSM”) may include one or more OS-specific functions to be performed in connection with any number of different operating systems (see, e.g., FIGS. 5 and 6 and associated discussion). For example, the OS-specific functions may include functions for exposing one or more OS-specific platform features and/or OS-specific platform objects to a particular OS 126, enabling (e.g., adding features and/or objects to an ACPI namespace, loading, etc.) one or more OS-specific platform features and/or OS-specific platform objects for a particular OS 126, hiding (e.g., preventing exposure) one or more OS-specific platform features and/or OS-specific platform objects from a particular OS 126, and/or disabling (e.g., removing features and/or objects from the ACPI namespace, unloading, etc.) one or more OS-specific platform features and/or OS-specific platform objects for a particular OS 126. Each OS 126 included in the OS-specific function specification (e.g., the “_DSM”) may be identified by a unique identifier (e.g, a Globally Unique IDentifier or “GUID,” a Universally Unique IDentifier or “UUID,” etc.). The unique identifier for each OS 126 may be embodied as one or more letters, numbers, symbols, strings, and/or the like that uniquely identifies an OS 126 from other OSs 126. As discussed in more detail below, by controlling the specific functions performed based on the OS 126 being initialized, hardware vendors and/or device administrators may selectively enable and/or disable OS-specific features and/or objects available to the particular OS 126 being initialized.

The ACPI subsystem module 120 may also be configured to determine which OS-specific functions are to be performed based on the particular OS 126 being initialized. To do so, the ACPI subsystem module 120 is configured to receive a call from the virtual device driver logic 204. In some embodiments, the call received from the virtual device driver logic 204 includes the unique identifier of the OS 126 being initialized. As such, the ACPI subsystem module 120 is configured to analyze the OS-specific function specification (e.g., the “_DSM”) to determine whether the received unique identifier matches any of the unique identifiers associated with the OS-specific functions included within the OS-specific function specification. If the ACPI subsystem module 120 determines that the received unique identifier matches one of the unique identifiers within the OS-specific function specification, the ACPI subsystem module 120 may be configured to perform the corresponding function.

In other embodiments, the ACPI subsystem module 120 may be configured to perform one or more functions based on one or more function identifiers received from the virtual device driver logic 204. In such embodiments, the ACPI subsystem module 120 may be configured to load device data and/or object data corresponding to the virtual ACPI device and general function specification associated with the virtual ACPI device into one or more ACPI tables. The function specification associated with the virtual ACPI device may be embodied as a device specific method or “_DSM” and may include one or more OS-specific functions for various different operating systems (OSs). In some embodiments, each of the OS-specific functions may be numbered or otherwise include a function identifier. The function identifier for each OS-specific function may be embodied as one or more letters, numbers, symbols, strings, and/or the like that uniquely identifies the OS-specific function from other OS-specific functions. Accordingly, the call received by the ACPI subsystem module 120 may include one or more unique function identifiers corresponding to the one or more OS-specific functions that should be performed for the OS 126 being initialized. The ACPI subsystem module 120 is configured to analyze the function specification (e.g., the “_DSM”) to determine whether one or more of the received function identifiers match any of the function identifiers included within the function specification. If the ACPI subsystem module 120 determines that a received function identifier matches one of the function identifiers within the function specification, the ACPI subsystem module 120 may be configured to perform the corresponding function.

The operating system (OS) 126 may be embodied as any type of OS, or other similar set of instructions, for performing the functions and/or providing the features described herein. For example, in various embodiments, the OS 126 may be embodied as a version of Windows®, which is commercially available from Microsoft Corp. of Redmond, Wash.; a version of Linux (including Android™, which is commercially available from Google, Inc. of Mountain View, Calif.); OS X®, which is commercially available from Apple Inc. of Cupertino, Calif., a version of UNIX®; and/or any other type of OS 126. In use, the OS 126 may manage hardware and software resources for one or more applications executed by the computing device 110. In some embodiments, the OS 126 may be configured to communicate and/or interact with the ACPI subsystem module 120 or one or more components of the ACPI subsystem (e.g., the virtual ACPI device, the OS-specific function specification, the function specification, etc.) via the default ACPI driver logic 202 and/or the virtual device driver logic 204. For example, during initialization of the OS 126 by the computing device 110, the OS 126 (via an associated OS loader or other component) may initialize and/or load the default ACPI driver logic 202, which may be configured to enable the OS 126 to interact and/or communicate with the ACPI subsystem module 120. The OS 126 may also initialize the virtual device driver logic 204, which as discussed below in more detail, may be configured to enable the OS 126 to interact and/or communicate with the virtual ACPI device loaded by the ACPI subsystem module 120.

The default ACPI driver logic 202 may be configured to communicate and/or interact with the ACPI subsystem module 120 or one or more components of the ACPI subsystem module 120 (e.g., the virtual ACPI device, the OS-specific function specification, the function specification, etc.). In some embodiments, the default ACPI driver logic 202 may be configured to be initialized during the initial stages of the OS 126 booting process. For example, the default ACPI driver logic 202 may be initialized by the OS 126 prior to initialization of other driver logic (e.g., the virtual device driver logic 204, video device driver logic, input/output driver logic, etc.). In such embodiments, the ACPI subsystem module 120 may interact with the OS 126 prior to initialization of one or more other components and/or features of the computing device 110. It should be appreciated that although the default ACPI driver logic 202 is described in the illustrative embodiment as being “default” ACPI driver logic, the default ACPI driver logic 202 may be any type of driver logic (e.g., standard or universal ACPI driver logic provided by an OS vendor and/or hardware vendor, open source ACPI driver logic, proprietary driver logic, etc.). Thus, as used herein, the term “default ACPI driver logic” is intended to cover any driver logic configured to enable initial interactions between the OS 126 and the ACPI subsystem module 120 during initialization of the OS 126.

The virtual device driver logic 204 may be configured to interact and/or communicate with the virtual ACPI device loaded by the ACPI subsystem module 120. In some embodiments, the virtual device driver logic 204 may be initialized by the OS 126 subsequent to initialization of the default ACPI driver logic 202. The virtual device driver logic 204 may be specific to the particular OS 126 being loaded (e.g., initialized, booted, executed, etc.) and may facilitate the determination of which OS-specific function(s) should be performed by the ACPI subsystem module 120 (see, e.g., FIGS. 5 and 6 and associated discussion). For example, in some embodiments, the virtual device driver logic 204 may include a unique identifier (e.g., a GUID, a UUID, etc.) that uniquely identifies which OS 126 the virtual device driver is configured to interact with. In other embodiments, the virtual device driver logic 204 may include one or more function identifiers that uniquely identify OS-specific functions to be performed for the OS 126 being initialized. In such embodiments, as discussed below, the virtual device driver logic 204 may be configured to transmit a call to the ACPI subsystem module 120 that includes the unique identifier of the OS 126 being initialized and/or the function identifier(s) associated with the particular function to be performed. The ACPI subsystem module 120 may compare the received identifier(s) to determine the OS-specific functions that should be performed for the OS 126.

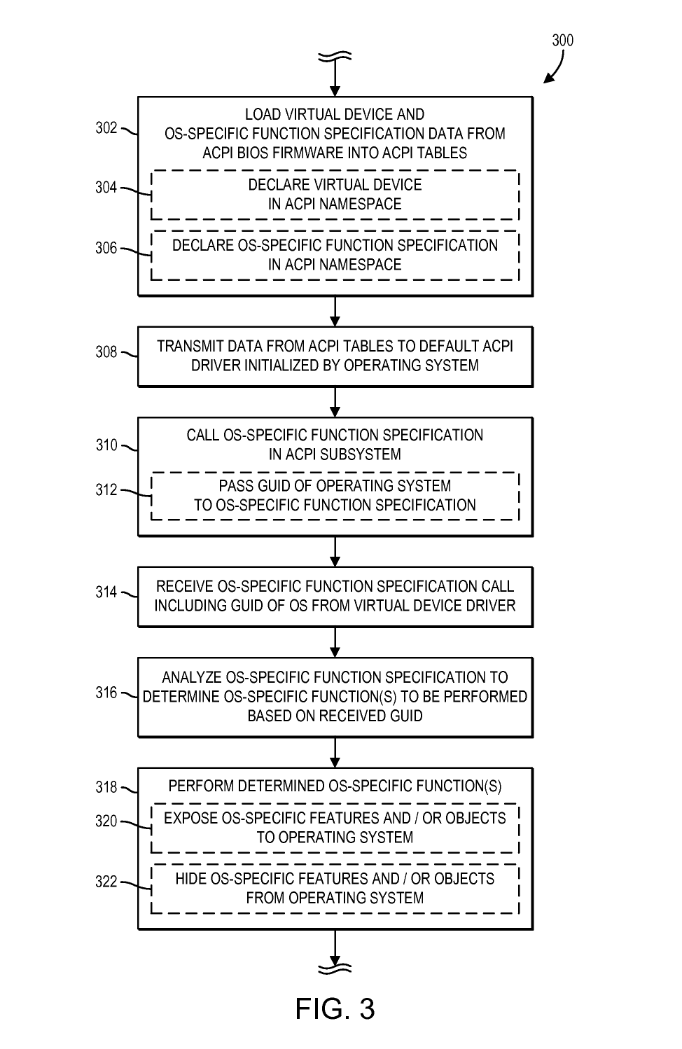

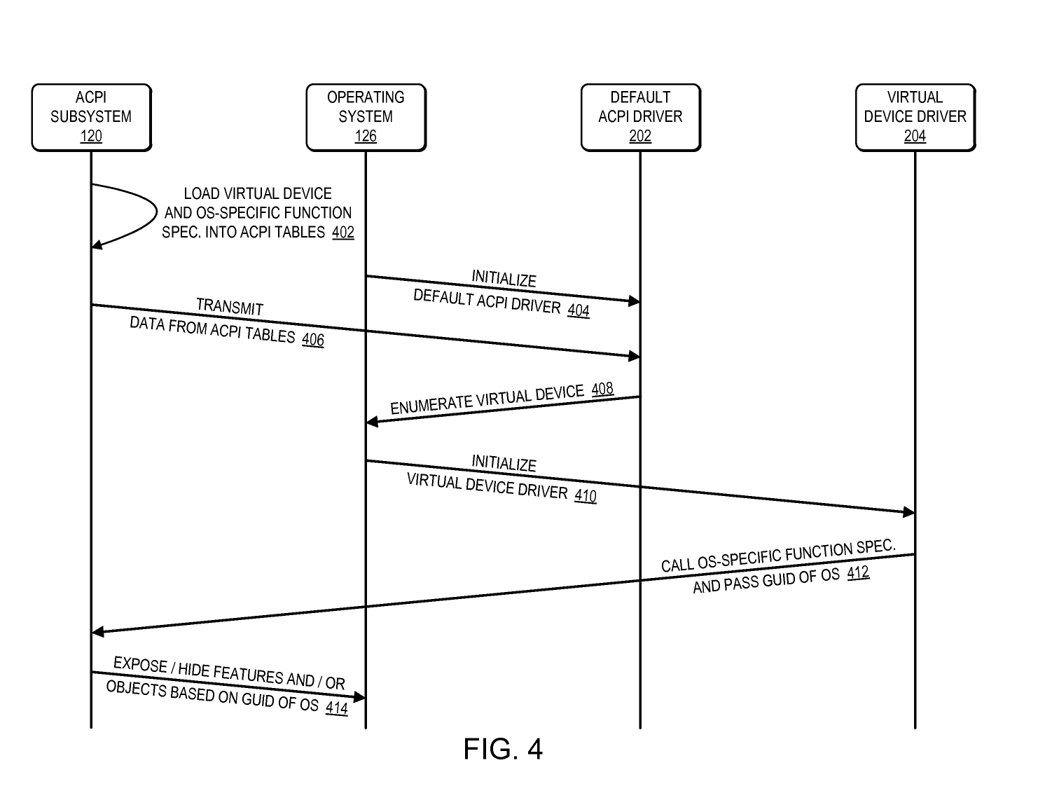

Referring now to FIG. 3, the computing device 110 may execute a method 300 for selectively enabling platform-specific features. The method 300 begins with block 302 in which the ACPI subsystem 120 of the computing device 110 loads device data and/or object data indicative of a virtual ACPI device (e.g., a virtual ACPI object, etc.) and an associated OS-specific function specification (e.g., a _DSM, a control method, etc.) into one or more ACPI tables (e.g., data flow 402 illustratively shown in FIG. 4). The ACPI table(s) may be embodied as any type of data structure stored on the computing device 110 in which data associated with the ACPI subsystem 120, or any component thereof, may be stored for later use by the ACPI subsystem 120 and/or the OS 126 being loaded. For example, in some embodiments, the ACPI tables may include one or more ACPI devices, features, objects, device specific methods, and/or the like that may be enumerated and/or interacted with by the OS 126 during initialization and/or during later stages of execution (e.g., runtime). In some embodiments, the device data loaded into the ACPI table(s) may be loaded from ACPI basic input/output system (BIOS) firmware of the computing device 110. It should be appreciated, however, that the device data loaded into the ACPI table(s) may be loaded from any other component of the computing device 110 (e.g., the memory 114, the data storage 124, etc.). In some embodiments, in blocks 304 and 306, the ACPI virtual device and the OS-specific function specification may be declared in an ACPI namespace to facilitate later enumeration by and/or interaction with the OS 126 during the booting process (e.g., initialization of OS 126) and/or during normal execution (e.g., runtime).

As discussed, in some embodiments, the OS-specific function specification (e.g., the “_DSM”) associated with the virtual ACPI device may include one or more OS-specific functions for various different operating systems (OSs). Each OS 126 included in the OS-specific function specification may be identified by a unique identifier (e.g., a Globally Unique IDentifier or “GUID,” a Universally Unique IDentifier or “UUID,” etc.). Additionally, in some embodiments, the OS-specific function(s) may be grouped based on the particular OS 126 with which they are associated. In such embodiments, the unique identifier for a particular OS 126 may be used to group (e.g., partition, separate, arrange, etc.) the OS-specific function(s) for that OS 126 from the OS-specific functions(s) for other OSs 126. For example, as illustratively shown in FIG. 5, an OS-specific function specification (e.g., the “_DSM” 500) may include one or more OS-specific functions 512, 522, 532 for each OS 126 listed therein. The OS-specific functions 512, 522, 532 may be grouped or otherwise arranged according to the particular OS 126 with which they are associated. To facilitate grouping the OS-specific functions 512, 522, 532, each OS 126 of the OS-specific function specification (e.g., the “_DSM” 500) may also be associated with a different unique identifier (e.g., the GUIDs 510, 520, 530). In some embodiments, the unique identifiers (e.g., the GUIDs 510, 520, 530) may also be used to facilitate the later performance of one or more of the OS-specific functions 512, 522, 532 based on the identity of the particular OS 126 being initialized (e.g., loaded, booted, executed, etc.).

Referring back to FIG. 3, in block 308, the ACPI subsystem 120 transmits the device data from the ACPI table(s) to a default ACPI driver 202 initialized by the OS 126 being booted (e.g., data flows 404 and 406 illustratively shown in FIG. 4). In some embodiments, the default ACPI driver 202 may be initialized by the OS 126 prior to initialization of other drivers (e.g., the virtual device driver 204, video device drivers, input/output drivers, etc.). In such embodiments, the default ACPI driver 202 is configured to enable the OS 126 to communicate, interact, or otherwise interface with the ACPI subsystem 120 prior to initialization of one or more other components and/or features of the computing device 110. Additionally, in some embodiments, the device data transmitted to the default ACPI driver 202 may be used by the OS 126 to enumerate the virtual ACPI device (e.g., data flow 408 illustratively shown in FIG. 4) and/or any other ACPI devices, features, components, objects, control methods, etc. of the ACPI subsystem 120. It should be appreciated that although the default ACPI driver 202 is described in the illustrative embodiment as being a “default” ACPI driver, the default ACPI driver 202 may be any type of driver (e.g., a standard or universal ACPI driver provided by an OS vendor and/or hardware vendor, an open source ACPI driver, a proprietary driver, etc.). Thus, as used herein, the term “default ACPI driver” is intended to cover any driver configured to enable initial interactions between the OS 126 and the ACPI subsystem 120 during initialization of the OS 126.

In block 310, the computing device 110 transmits a call to the OS-specific function specification in the ACPI subsystem 120 (e.g., data flow 412 illustratively shown in FIG. 4). In some embodiments, the call to the OS-specific function specification is transmitted by the virtual device driver 204, which may be initialized by the OS 126 being booted (e.g., data flow 410 illustratively shown in FIG. 4). Additionally, in some embodiments, the virtual device driver 204 may be initialized by the OS 126 subsequent to initialization of the default ACPI driver 202 and is configured to interface (e.g., interact, communicate, etc.) with the virtual ACPI device of the ACPI subsystem 120. As discussed, the virtual device driver 204 may be specific to the particular OS 126 being loaded and may include a unique identifier (e.g., a GUID, a UUID, etc.) that uniquely identifies that OS 126 from other OSs 126. As such, the call to the OS-specific function specification (e.g., the “_DSM”) in the ACPI subsystem 120 may include the unique identifier (e.g., the GUID) of the OS 126 being loaded based on the unique identifier obtained from the virtual device driver 204. Additionally, in some embodiments, in block 312, the virtual device driver 204 may pass the unique identifier (e.g., the GUID) as an argument to the OS-specific function specification (e.g., the “_DSM”) in the ACPI subsystem 120 via the call. It should be appreciated that any other technique for transmitting or otherwise delivering the unique identifier (e.g, the GUID) may also be used by the computing device 110 and/or the virtual device driver 204.

In block 314, the ACPI subsystem 120 of the computing device 110 receives the call including the unique identifier (e.g., the GUID) of the OS 126 being loaded from the virtual device driver 204. Subsequently, in block 316, the ACPI subsystem 120 of the computing device 110 analyzes the OS-specific function specification (e.g., the “_DSM”) to determine the one or more OS-specific functions that are to be performed for the OS 126 being initialized based on the unique identifier (e.g., the GUID) received with the call from the virtual device driver 204. To do so, the ACPI subsystem 120 may compare the unique identifier received from the virtual device driver 204 of the OS being initialized to the unique identifiers included in the OS-specific function specification (e.g., the “_DSM”). In response to determining that the received unique identifier matches one of the unique identifiers included in the OS-specific function specification, the ACPI subsystem 120 may determine that the OS-specific function(s) for the OS 126 associated with the matching identifier should be performed.

In block 318, the ACPI subsystem 120 of the computing device 110 performs the OS-specific function(s) for the OS 126 determined based on the received unique identifier. For example, in some embodiments, in block 320, the ACPI subsystem 120 exposes an OS-specific feature and/or an OS-specific object to the OS 126 being initialized (e.g., data flow 414 illustratively shown in FIG. 4). Additionally or alternatively, in block 322, the ACPI subsystem 120 hides an OS-specific feature and/or an OS-specific object from the OS 126 being initialized.

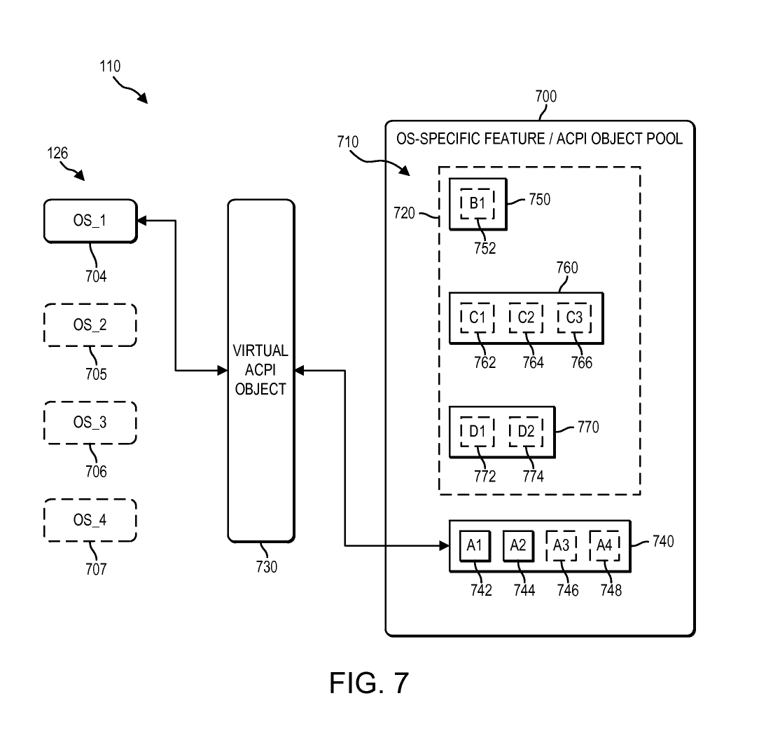

It should be appreciated that by controlling the specific functions that are performed in response to first identifying the OS 126 that is being initialized and/or the specific functions that are to be performed for the OS 126, the ACPI subsystem 120 may selectively enable and/or disable OS-specific features for the OS 126 being initialized. For example, as illustratively shown in FIG. 7, a computing device 110 may include firmware (e.g., the BIOS 118) that provides a pool 700 of features and/or objects 710 for use by various different OSs 126 (e.g., the OS_1 704, OS_2 705, OS_3 706, OS_4 707). In some embodiments, one or more of the features and/or objects 710 provided by the firmware may be OS-specific. For example, the firmware may include a group of features and/or objects 740 (e.g., A1 742, A2 744, A3 746, A4 748) specific to the OS_1 704; a group of features and/or objects 750 (e.g., B1 752) specific to the OS_2 705; a group of features and/or objects 760 (e.g., C1 762, C2 764, C3 766) specific to the OS_3 706; and a group of features and/or objects 770 (e.g., D1 772, D2 774) specific to the OS_4 707. In some embodiments, a virtual ACPI object 730 (e.g., the virtual ACPI device) and other components of the ACPI subsystem 120 may be configured to interact with an OS 126 being initialized (e.g., the OS_1 704). In response to identifying the particular OS 126 (e.g., the OS_704) being initialized, the ACPI subsystem 120 may perform one or more function(s) specific to the OS_1 704 configured to disable or hide 720 the features and/or objects (e.g., B1 752, C1 762, C2 764, C3 766, D1 772, D2 774) associated with the other OSs 126 (e.g., the OS_2 705, OS_3 706, OS_4 707) not being initialized. In addition, the ACPI subsystem 120 may perform one or more function(s) specific to the OS_1 704 configured to enable or expose one or more of the features and/or objects (e.g., A1 742, A2 744) associated with the OS_1 704. Additionally or alternatively, the ACPI subsystem 120 may perform one or more function(s) specific to the OS_1 704 configured to disable or hide one or more of the features and/or objects (e.g., A3 746, A4 748) associated with the OS_1 704.

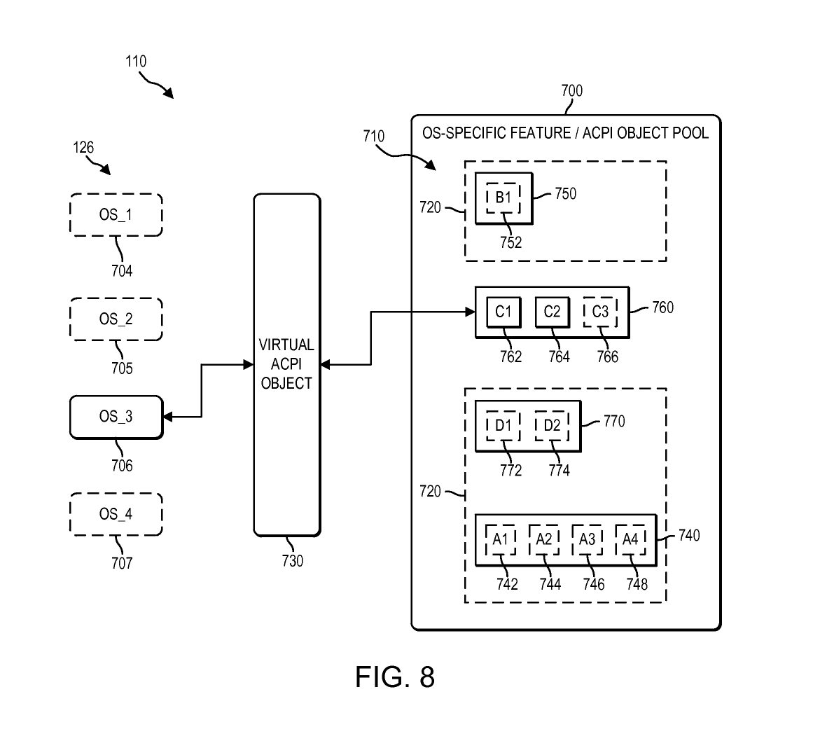

Referring now to FIG. 8, another illustrative example of selectively enabling and disabling features for a different OS 126 (e.g., the OS_3 706) being initialized is shown. As shown, in response to identifying that the OS_3 706 is being initialized, the ACPI subsystem 120 may perform one or more function(s) specific to the OS_3 706 configured to disable or hide 720 the features and/or objects (e.g., A1 742, A2 744, A3 746, A4 748, B1 752, D1 772, D2 774) associated with the other OSs 126 (e.g., the OS_1 704, OS_2 705, OS_4 707) not being initialized. In addition, the ACPI subsystem 120 may perform one or more function(s) specific to the OS_3 706 configured to enable or expose one or more of the features and/or objects (e.g., C1 762, C2 764) associated with the OS_3 706. Additionally or alternatively, the ACPI subsystem 120 may perform one or more function(s) specific to the OS_3 706 configured to disable or hide one or more of the features and/or objects (e.g., C3 766) associated with the OS_3 706.

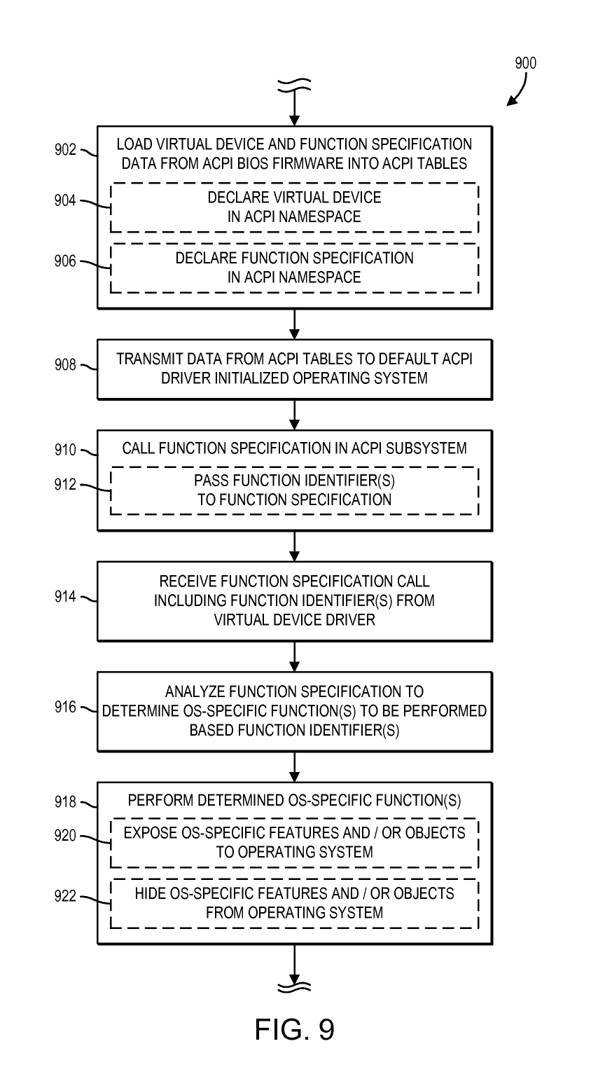

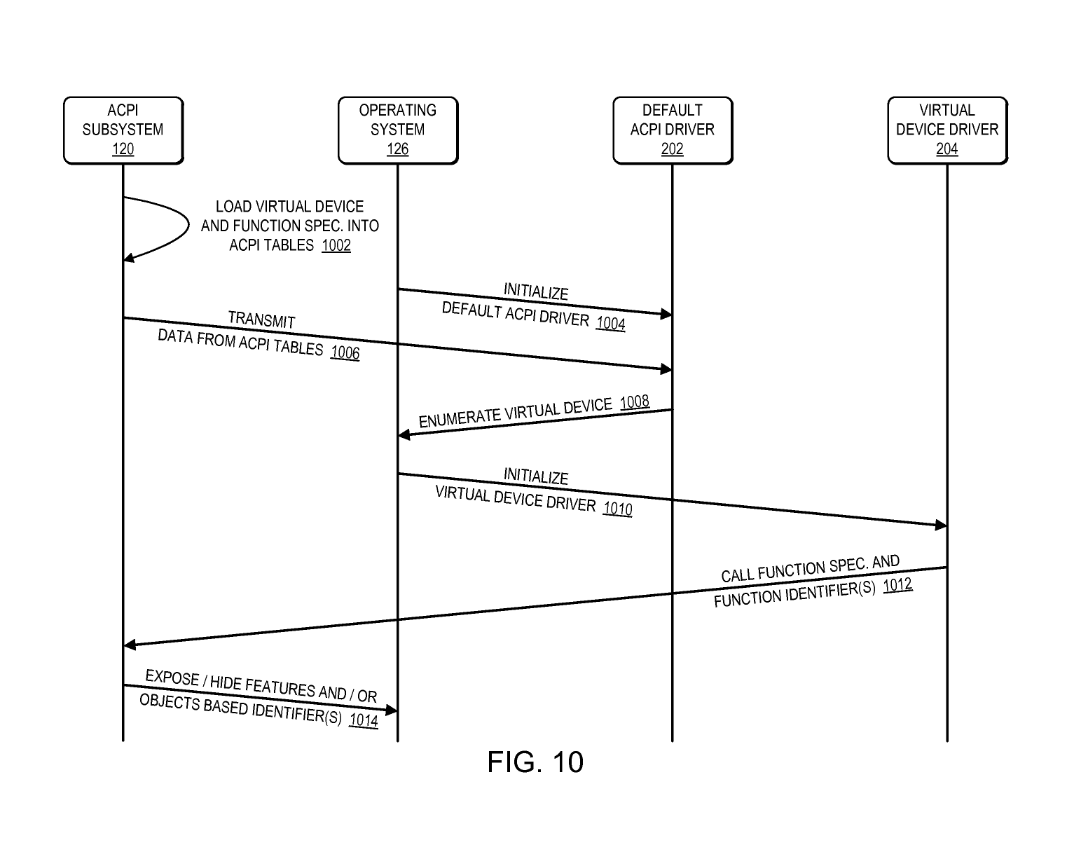

Referring now to FIG. 9, in some embodiments, the computing device 110 may execute a method 900 for selectively enabling platform-specific features. The method 900 begins with block 902 in which the ACPI subsystem 120 of the computing device 110 loads device data and/or object data indicative of a virtual ACPI device (e.g., a virtual ACPI object, etc.) and an associated function specification (e.g., a _DSM, a control method, etc.) into one or more ACPI tables (e.g., data flow 1002 illustratively shown in FIG. 10). The ACPI table(s) may be embodied as any type of data structure stored on the computing device 110 in which data associated with the ACPI subsystem 120, or any component thereof, may be stored for later use by the ACPI subsystem 120 and/or the OS 126 being loaded. In some embodiments, the device data loaded into the ACPI table(s) may be loaded from ACPI basic input/output system (BIOS) firmware of the computing device 110. It should be appreciated, however, that the device data loaded into the ACPI table(s) may be loaded from any other component of the computing device 110 (e.g., the memory 114, the data storage 124, etc.). In some embodiments, in blocks 904 and 906, the ACPI virtual device and the function specification (e.g., “the “_DSM””) may be declared in an ACPI namespace to facilitate later enumeration by the OS 126 during the booting process (e.g., initialization of OS 126).

As discussed, in some embodiments, the function specification (e.g., “the “_DSM””) associated with the virtual ACPI device may include one or more OS-specific functions for various different operating systems (OSs). In such embodiments, the function specification may include an identifier (e.g., a GUID, a UUID, etc.) for use with all of the OS-specific function(s) and OSs 126 included therein. However, each of the OS-specific functions may numbered or otherwise include a function identifier to facilitate later identification by the ACPI subsystem 120. The function identifier for each OS-specific function may be embodied as one or more letters, numbers, symbols, strings, and/or the like that uniquely identifies the OS-specific function from other OS-specific functions. As discussed in more detail below, the OS-specific functions and their associated function identifiers may correspond to one or more OS-specific functions and function identifiers included within the virtual device driver 204. In some embodiments, the OS-specific functions may be grouped or arranged within the function specification based on the particular OS 126 to which they are associated. Additionally, in such embodiments, the OS-specific functions may be numbered consecutively to facilitate later identification by the ACPI subsystem 120. For example, as illustratively shown in FIG. 6, a function specification (e.g., the “_DSM” 600) may include one or more OS-specific functions 612 for one or more OSs 126. The OS-specific functions 612 may be grouped or otherwise arranged according to the particular OS 126 with which they are associated. Additionally, the illustrative function specification (e.g., the “_DSM” 600) includes a single identifier (e.g., the GUID 610) for use with all of the OS-specific functions 612 included therein.

Referring back to FIG. 9, in block 908, the ACPI subsystem 120 transmits the device data from the ACPI table(s) to a default ACPI driver 202 initialized by the OS 126 being booted (e.g., data flows 1004 and 1006 illustratively shown in FIG. 10). In some embodiments, the default ACPI driver 202 may be initialized by the OS 126 prior to initialization of other drivers (e.g., the virtual device driver 204, video device drivers, input/output drivers, etc.). In such embodiments, the default ACPI driver 202 is configured to enable the OS 126 to communicate, interact, or otherwise interface with the ACPI subsystem 120 prior to initialization of one or more other components and/or features of the computing device 110. In some embodiments, the device data transmitted to the default ACPI driver 202 may be used by the OS 126 to enumerate the virtual ACPI device (e.g., data flow 1008 illustratively shown in FIG. 10).

In block 910, the computing device 110 transmits a call to the function specification in the ACPI subsystem 120 (e.g., data flow 1012 illustratively shown in FIG. 10). In some embodiments, the call to the function specification in the ACPI subsystem 120 is transmitted by the virtual device driver 204, which may be initialized by the OS 126 being booted (e.g., data flow 1010 illustratively shown in FIG. 10). Additionally, in some embodiments, the virtual device driver 204 may be initialized by the OS 126 subsequent to initialization of the default ACPI driver 202 and is configured to interface (e.g., interact, communicate, etc.) with the virtual ACPI device of the ACPI subsystem 120. The virtual device driver 204 may be specific to the particular OS 126 being loaded and may include a list of one or more OS-specific functions. In some embodiments, each OS-specific function listed may correspond to a different OS-specific function included in the function specification (e.g., the “_DSM”). Likewise, each OS-specific function listed may include a function identifier that is consistent with the function identifier of the corresponding OS-specific function included in the function specification. As such, the call to the function specification (e.g., the “_DSM”) in the ACPI subsystem 120 may include one or more function identifier(s) associated with one or more OS-specific functions that are to be performed. Additionally, in some embodiments, in block 912, the virtual device driver 204 may pass the function identifier(s) as an argument to the function specification (e.g., the “_DSM”) in the ACPI subsystem 120 via the call. It should be appreciated that any other technique for transmitting or otherwise delivering the function identifier(s) may also be used by the computing device 110 and/or the virtual device driver 204.

In block 914, the ACPI subsystem 120 of the computing device 110 receives the call including the function identifier(s) from the virtual device driver 204. Subsequently, in block 916, the ACPI subsystem 120 of the computing device 110 analyzes the function specification (e.g., the “_DSM”) to determine the one or more OS-specific functions that are to be performed for the OS 126 being initialized based on the function identifier(s) received with the call from the virtual device driver 204. To do so, the ACPI subsystem 120 may compare the function identifier(s) received from the virtual device driver 204 of the OS being initialized to the corresponding function identifier(s) included in the function specification (e.g., the “_DSM”). In response to determining that a received function identifier matches one of the corresponding function identifier(s) included in the function specification, the ACPI subsystem 120 may determine that the OS-specific function associated with the matching function identifier should be performed.

In block 918, the ACPI subsystem 120 of the computing device 110 performs the OS-specific function(s) for the OS 126 determined based on the received function identifier(s). For example, in some embodiments, in block 920, the ACPI subsystem 120 exposes an OS-specific feature and/or an OS-specific object to the OS 126 being initialized (e.g., data flow 1014 illustratively shown in FIG. 10). Additionally or alternatively, in block 922, the ACPI subsystem 120 hides an OS-specific feature and/or an OS-specific object from the OS 126 being initialized.

It should be appreciated that by use of the technologies disclosed herein, hardware vendors and/or computing device administrators may selectively enable and disable OS-specific features and/or objects based on the particular operating system 126 being initialized (e.g., booted, loaded, executed, etc.). To do so, hardware vendors and/or computing device administrators may release firmware (e.g., BIOS 118, ACPI subsystem 120, etc.) configured to support various different OSs 126 on the same or similar hardware device and/or platform. The firmware may provide an ACPI subsystem 120 and/or framework that includes a virtual ACPI device (e.g, a virtual ACPI object) and an OS-specific function specification (or a function specification) associated therewith. A separate, OS-specific virtual device driver may also be provided for each OS supported. Each virtual device driver 204, when initialized by an OS 126 being booted, enables the identity of the particular OS 126 being booted and/or the identity of one or more OS-specific functions to be ascertained by the ACPI subsystem 120. In response, the ACPI subsystem 120 may perform the function(s) specific to the OS 126 being initialized. As such, by controlling the specific functions that are to be performed based on the identity of the particular OS 126 being booted and/or the identities of the specific functions to be performed for the particular OS 126 being booted, hardware vendors may use the ACPI subsystem 120 to selectively enable and disable OS-specific features and/or objects for that OS 126.

### EXAMPLES

Illustrative examples of the technologies disclosed herein are provided below. An embodiment of the technologies may include any one or more, and any combination of, the examples described below.

Example 1 includes a computing device to selectively enable platform-specific features, the computing device includes an Advanced Configuration and Power Interface (ACPI) subsystem including an operating system (OS)-specific function specification associated with a virtual device of the ACPI subsystem, the OS-specific function specification including a plurality of OS-specific functions; and a virtual device driver logic to be initialized by an OS of the computing device, the virtual device driver logic to (i) interface with the virtual device of the ACPI subsystem and (ii) transmit a call to the OS-specific function specification in the ACPI subsystem, the call including an identifier of the OS that uniquely identifies the OS from other operating systems, wherein the ACPI subsystem is to (i) analyze the OS-specific function specification to determine one or more OS-specific functions of the plurality of OS-specific functions for the OS based on the identifier from the call that uniquely identifies the OS and (ii) perform the one or more OS-specific functions determined for the OS based on the identifier.

Example 2 includes the subject matter of Example 1, and wherein the OS-specific function specification associated with the virtual device includes an ACPI device specific method (DSM) associated with the virtual device or a custom ACPI control method associated with the virtual device.

Example 3 includes the subject matter of any of Examples 1 and 2, and wherein at least one of the plurality of OS-specific functions includes an OS-specific function configured to at least one of (i) expose an OS-specific feature to the OS or (ii) expose an OS-specific object to the OS.

Example 4 includes the subject matter of any of Examples 1-3, and wherein at least one of the plurality of OS-specific functions includes an OS-specific function configured to at least one of (i) hide an OS-specific feature from the OS or (ii) hide an OS-specific object from the OS.

Example 5 includes the subject matter of any of Examples 1-4, and wherein to transmit the call to the OS-specific function specification in the ACPI subsystem includes to transmit the call to the OS-specific function specification in the ACPI subsystem and pass the identifier of the OS as an argument.

Example 6 includes the subject matter of any of Examples 1-5, and wherein the OS-specific function specification associated with the virtual device includes at least one OS-specific function associated with each of a plurality of different operating systems, each OS of the plurality operating systems has a different identifier that uniquely identifies the OS from other operating systems.

Example 7 includes the subject matter of any of Examples 1-6, and wherein the OS includes a first OS and the identifier includes a first identifier that uniquely identifies the first OS from other operating systems; wherein the plurality of OS-specific functions of the OS-specific function specification includes a first group of OS-specific functions for the first OS and a second group of OS-specific functions for second OS of the computing device different from the first OS; and wherein the first group of OS-specific functions is identified in the OS-specific function specification by the first identifier and the second group of OS-specific functions is identified in the OS-specific function specification by a second identifier different from the first identifier.

Example 8 includes the subject matter of any of Examples 1-7, and further including an ACPI driver logic to be initialized by the OS of the computing device, the ACPI driver logic to interface with the ACPI subsystem prior to initialization of the virtual device driver logic, wherein the ACPI driver logic is different from the virtual device driver logic; wherein the ACPI subsystem is further to (i) load device data into an ACPI table associated with the ACPI subsystem, wherein the device data is indicative of the virtual device of the ACPI subsystem and the OS-specific function specification associated with the virtual device and (ii) transmit the device data from the ACPI table to the ACPI driver logic; and wherein in response to receipt of the device data from the ACPI table by the ACPI driver logic, the OS is to enumerate the virtual device.

Example 9 includes the subject matter of any of Examples 1-8, and wherein to load the device data into the ACPI table includes to load device data into the ACPI table from ACPI basic input/output system (BIOS) firmware of the computing device.

Example 10 includes a method for selectively enabling platform-specific features on a computing device, the method including initializing, by an operating system (OS) of the computing device, a virtual device driver to interface with a virtual device of an Advanced Configuration and Power Interface (ACPI) subsystem of the computing device, the ACPI subsystem including an OS-specific function specification associated with the virtual device, and wherein the OS-specific function specification including a plurality of OS-specific functions; transmitting, by the virtual device driver, a call to the OS-specific function specification in the ACPI subsystem, the call including an identifier of the OS that uniquely identifies the OS from other operating systems; analyzing, by the ACPI subsystem, the OS-specific function specification to determine one or more OS-specific functions of the plurality of OS-specific functions for the OS based on the identifier from the call that uniquely identifies the OS; and performing, by the ACPI subsystem, the one or more OS-specific functions determined for the OS based on the identifier.

Example 11 includes the subject matter of Example 10, and wherein the OS-specific function specification associated with the virtual device includes an ACPI device specific method (DSM) associated with the virtual device or a custom ACPI control method associated with the virtual device.

Example 12 includes the subject matter of any of Examples 10 and 11, and wherein at least one of the plurality of OS-specific functions includes an OS-specific function configured to at least one of (i) expose an OS-specific feature to the OS or (ii) expose an OS-specific object to the OS.

Example 13 includes the subject matter of any of Examples 10-12, and wherein at least one of the plurality of OS-specific functions includes an OS-specific function configured to at least one of (i) hide an OS-specific feature from the OS or (ii) hide an OS-specific object from the OS.

Example 14 includes the subject matter of any of Examples 10-13, and wherein transmitting the call to the OS-specific function specification in the ACPI subsystem includes transmitting the call to the OS-specific function specification in the ACPI subsystem and passing the identifier of the OS as an argument.

Example 15 includes the subject matter of any of Examples 10-14, and wherein the OS-specific function specification associated with the virtual device includes at least one OS-specific function associated with each of a plurality of different operating systems, each OS of the plurality of operating systems having a different identifier that uniquely identifies the OS from other operating systems.

Example 16 includes the subject matter of any of Examples 10-15, and wherein the OS includes a first OS and the identifier includes a first identifier that uniquely identifies the first OS from other operating systems; wherein the plurality of OS-specific functions of the OS-specific function specification includes a first group of OS-specific functions for the first OS and a second group of OS-specific functions for a second OS of the computing device different from the first OS; and wherein the first group of OS-specific functions is identified in the OS-specific function specification by the first identifier and the second group of OS-specific functions is identified in the OS-specific function specification by a second identifier different from the first identifier.

Example 17 includes the subject matter of any of Examples 10-16, and further including: loading, by the ACPI subsystem of the computing device, device data into an ACPI table associated with the ACPI subsystem, wherein the device data is indicative of the virtual device of the ACPI subsystem and the OS-specific function specification associated with the virtual device; initializing, by the OS of the computing device, an ACPI driver to interface with the ACPI subsystem prior to initialization of the virtual device driver, wherein the ACPI driver is different from the virtual device driver; transmitting, by the ACPI subsystem, the device data from the ACPI table to the ACPI driver; and enumerating, by the OS of the computing device, the virtual device in response to the ACPI driver receiving the device data from the ACPI table.

Example 18 includes the subject matter of any of Examples 10-17, and wherein loading the device data into the ACPI table includes loading device data into the ACPI table from ACPI basic input/output system (BIOS) firmware of the computing device.

Example 19 includes a computing device to selectively enable platform-specific features, the computing device including a processor; and a memory having stored therein a plurality of instructions that when executed by the processor cause the computing device to perform the method of any of Examples 10-18.

Example 20 includes one or more machine-readable media including a plurality of instructions stored thereon that in response to being executed result in a computing device performing the method of any of Examples 10-18.

Example 21 includes a computing device to selectively enable platform-specific features, the computing device including means for initializing, by an operating system (OS) of the computing device, a virtual device driver to interface with a virtual device of an Advanced Configuration and Power Interface (ACPI) subsystem of the computing device, the ACPI subsystem including an OS-specific function specification associated with the virtual device, and wherein the OS-specific function specification includes a plurality of OS-specific functions; means for transmitting, by the virtual device driver, a call to the OS-specific function specification in the ACPI subsystem, the call including an identifier of the OS that uniquely identifies the OS from other operating systems; means for analyzing, by the ACPI subsystem, the OS-specific function specification to determine one or more OS-specific functions of the plurality of OS-specific functions for the OS based on the identifier from the call that uniquely identifies the OS; and means for performing, by the ACPI subsystem, the one or more OS-specific functions determined for the OS based on the identifier.

Example 22 includes the subject matter of Example 21, and wherein the OS-specific function specification associated with the virtual device includes an ACPI device specific method (DSM) associated with the virtual device or a custom ACPI control method associated with the virtual device.

Example 23 includes the subject matter of any of Examples 21 and 22, and wherein at least one of the plurality of OS-specific functions includes an OS-specific function configured to at least one of (i) expose an OS-specific feature to the OS or (ii) expose an OS-specific object to the OS.

Example 24 includes the subject matter of any of Examples 21-23, and wherein at least one of the plurality of OS-specific functions includes an OS-specific function configured to at least one of (i) hide an OS-specific feature from the OS or (ii) hide an OS-specific object from the OS.

Example 25 includes the subject matter of any of Examples 21-24, and wherein the means for transmitting the call to the OS-specific function specification in the ACPI subsystem includes means for transmitting the call to the OS-specific function specification in the ACPI subsystem and means for passing the identifier of the OS as an argument.

Example 26 includes the subject matter of any of Examples 21-25, and wherein the OS-specific function specification associated with the virtual device includes at least one OS-specific function associated with each of a plurality of different operating systems, each OS of the plurality of operating systems having a different identifier that uniquely identifies the OS from other operating systems.

Example 27 includes the subject matter of any of Examples 21-26, and wherein the OS includes a first OS and the identifier includes a first identifier that uniquely identifies the first OS from other operating systems; wherein the plurality of OS-specific functions of the OS-specific function specification includes a first group of OS-specific functions for the first OS and a second group of OS-specific functions for a second OS of the computing device different from the first OS; and wherein the first group of OS-specific functions is identified in the OS-specific function specification by the first identifier and the second group of OS-specific functions is identified in the OS-specific function specification by a second identifier different from the first identifier.

Example 28 includes the subject matter of any of Examples 21-27, and further including: means for loading, by the ACPI subsystem of the computing device, device data into an ACPI table associated with the ACPI subsystem, wherein the device data is indicative of the virtual device of the ACPI subsystem and the OS-specific function specification associated with the virtual device; means for initializing, by the OS of the computing device, an ACPI driver to interface with the ACPI subsystem prior to initialization of the virtual device driver, wherein the ACPI driver is different from the virtual device driver; means for transmitting, by the ACPI subsystem, the device data from the ACPI table to the ACPI driver; and means for enumerating, by the OS of the computing device, the virtual device in response to the ACPI driver receiving the device data from the ACPI table.

Example 29 includes the subject matter of any of Examples 21-28, and wherein the means for loading the device data into the ACPI table includes means for loading device data into the ACPI table from ACPI basic input/output system (BIOS) firmware of the computing device.

Example 30 includes a computing device to selectively enable platform-specific features, the computing device includes an Advanced Configuration and Power Interface (ACPI) subsystem including a virtual device and a function specification associated with the virtual device, the function specification including a plurality of operating system (OS)-specific functions to be performed by the ACPI subsystem, wherein each OS-specific function of the plurality of OS-specific functions is associated with a function identifier that uniquely identifies the OS-specific function from other OS-specific functions; and a virtual device driver logic to be initialized by an OS of the computing device, wherein the virtual device driver logic is specific to the OS and is configured to (i) interface with the virtual device of the ACPI subsystem and (ii) transmit a call to the function specification in the ACPI subsystem, the call including one or more of the plurality of function identifiers of OS-specific functions of the function specification that correspond to the OS, wherein the ACPI subsystem to (i) analyze the function specification to determine the one or more OS-specific functions of the plurality of OS-specific functions based on the one or more function identifiers and (ii) perform the one or more OS-specific functions determined based on the one or more function identifiers.

Example 31 includes the subject matter of Example 30, and wherein the function specification associated with the virtual device includes an ACPI device specific method (DSM) associated with the virtual device.

Example 32 includes the subject matter of any of Examples 30 and 31, and wherein at least one of the plurality of OS-specific functions includes an OS-specific function configured to at least one of (i) expose an OS-specific feature to the OS or (ii) expose an OS-specific object to the OS.

Example 33 includes the subject matter of any of Examples 30-32, and wherein at least one of the plurality of OS-specific functions includes an OS-specific function configured to at least one of (i) hide an OS-specific feature from the OS or (ii) hide an OS-specific object from the OS.

Example 34 includes the subject matter of any of Examples 30-33, and further including an ACPI driver logic to be initialized by the OS of the computing device, the ACPI driver logic to interface with the ACPI subsystem prior to initialization of the virtual device driver logic, wherein the ACPI driver logic is different from the virtual device driver logic; wherein the ACPI subsystem is further to (i) load device data into an ACPI table associated with the ACPI subsystem, wherein the device data is indicative of the virtual device of the ACPI subsystem and the function specification associated with the virtual device and (ii) transmit the device data from the ACPI table to the ACPI driver logic; and wherein in response to receipt of the device data from the ACPI table by the ACPI driver logic, the OS is to enumerate the virtual device.

Example 35 includes the subject matter of any of Examples 30-34, and wherein to load the device data into the ACPI table includes to load device data into the ACPI table from ACPI basic input/output system (BIOS) firmware of the computing device.

Example 36 includes a method for selectively enabling platform-specific features on a computing device, the method including initializing, by an operating system (OS) of the computing device, a virtual device driver specific to the OS; interfacing, by the virtual device driver, with a virtual device of an Advanced Configuration and Power Interface (ACPI) subsystem, the ACPI subsystem including a function specification associated with the virtual device, the function specification including a plurality of OS-specific functions to be performed by the ACPI subsystem, wherein each OS-specific function of the plurality of OS-specific functions is associated with a function identifier that uniquely identifies the OS-specific function from other OS-specific functions; transmitting, by the virtual device driver, a call to the function specification in the ACPI subsystem, the call including one or more of the plurality of function identifiers of OS-specific functions of the function specification that correspond to the OS; analyzing, by the ACPI subsystem, the function specification to determine the one or more OS-specific functions of the plurality of OS-specific functions based on the one or more function identifiers; and performing, by the ACPI subsystem, the one or more OS-specific functions determined based on the one or more function identifiers.

Example 37 includes the subject matter of Example 36, and wherein the function specification associated with the virtual device includes an ACPI device specific method (DSM) associated with the virtual device or a custom ACPI control method associated with the virtual device.

Example 38 includes the subject matter of any of Examples 36 and 37, and wherein at least one of the plurality of OS-specific functions includes an OS-specific function configured to at least one of (i) expose an OS-specific feature to the OS or (ii) expose an OS-specific object to the OS.

Example 39 includes the subject matter of any of Examples 36-38, and wherein at least one of the plurality of OS-specific functions includes an OS-specific function configured to at least one of (i) hide an OS-specific feature from the OS or (ii) hide an OS-specific object from the OS.

Example 40 includes the subject matter of any of Examples 36-39, and further including initializing, by the OS of the computing device, an ACPI driver to interface with the ACPI subsystem prior to initialization of the virtual device driver, wherein the ACPI driver is different from the virtual device driver; loading, by the ACPI subsystem, device data into an ACPI table associated with the ACPI subsystem, wherein the device data is indicative of the virtual device of the ACPI subsystem and the function specification associated with the virtual device; transmitting, by the ACPI subsystem, the device data from the ACPI table to the ACPI driver; and enumerating, by the OS of the computing device, the device data from the ACPI table received by the ACPI driver.

Example 41 includes the subject matter of any of Examples 36-40, and wherein loading the device data into the ACPI table includes loading device data into the ACPI table from ACPI basic input/output system (BIOS) firmware of the computing device.

Example 42 includes a computing device to selectively enable platform-specific features, the computing device including a processor; and a memory having stored therein a plurality of instructions that when executed by the processor cause the computing device to perform the method of any of Examples 36-41.

Example 43 includes one or more machine-readable media including a plurality of instructions stored thereon that in response to being executed result in a computing device performing the method of any of Examples 36-41.

Example 44 includes a computing device to selectively enable platform-specific features, the computing device including means for initializing, by an operating system (OS) of the computing device, a virtual device driver specific to the OS; means for interfacing, by the virtual device driver, with a virtual device of an Advanced Configuration and Power Interface (ACPI) subsystem, the ACPI subsystem including a function specification associated with the virtual device, the function specification including a plurality of OS-specific functions to be performed by the ACPI subsystem, wherein each OS-specific function of the plurality of OS-specific functions is associated with a function identifier that uniquely identifies the OS-specific function from other OS-specific functions; means for transmitting, by the virtual device driver, a call to the function specification in the ACPI subsystem, the call including one or more of the plurality of function identifiers of OS-specific functions of the function specification that correspond to the OS; means for analyzing, by the ACPI subsystem, the function specification to determine the one or more OS-specific functions of the plurality of OS-specific functions based on the one or more function identifiers; and means for performing, by the ACPI subsystem, the one or more OS-specific functions determined based on the one or more function identifiers.

Example 45 includes the subject matter of Example 44, and wherein the function specification associated with the virtual device includes an ACPI device specific method (DSM) associated with the virtual device or a custom ACPI control method associated with the virtual device.

Example 46 includes the subject matter of any of Examples 44 and 45, and wherein at least one of the plurality of OS-specific functions includes an OS-specific function configured to at least one of (i) expose an OS-specific feature to the OS or (ii) expose an OS-specific object to the OS.

Example 47 includes the subject matter of any of Examples 44-46, and wherein at least one of the plurality of OS-specific functions includes an OS-specific function configured to at least one of (i) hide an OS-specific feature from the OS or (ii) hide an OS-specific object from the OS.

Example 48 includes the subject matter of any of Examples 44-47, and further including: means for initializing, by the OS of the computing device, an ACPI driver to interface with the ACPI subsystem prior to initialization of the virtual device driver, wherein the ACPI driver is different from the virtual device driver; means for loading, by the ACPI subsystem, device data into an ACPI table associated with the ACPI subsystem, wherein the device data is indicative of the virtual device of the ACPI subsystem and the function specification associated with the virtual device; means for transmitting, by the ACPI subsystem, the device data from the ACPI table to the ACPI driver; and means for enumerating, by the OS of the computing device, the device data from the ACPI table received by the ACPI driver.

Example 49 includes the subject matter of any of Examples 44-48, and wherein the means for loading the device data into the ACPI table includes means for loading device data into the ACPI table from ACPI basic input/output system (BIOS) firmware of the computing device.

1. A computing device to selectively enable platform-specific features, the computing device comprising:
an Advanced Configuration and Power Interface (ACPI) subsystem comprising an operating system (OS)-specific function specification associated with a virtual device of the ACPI subsystem, the OS-specific function specification comprising a plurality of OS-specific functions; and
a virtual device driver logic to be initialized by an OS of the computing device, the virtual device driver logic to (i) interface with the virtual device of the ACPI subsystem and (ii) transmit a call to the OS-specific function specification in the ACPI subsystem, the call comprising an identifier of the OS that uniquely identifies the OS from other operating systems,
wherein the ACPI subsystem is to (i) analyze the OS-specific function specification to determine one or more OS-specific functions of the plurality of OS-specific functions for the OS based on the identifier from the call that uniquely identifies the OS and (ii) perform the one or more OS-specific functions determined for the OS based on the identifier.

2. The computing device of claim 1, wherein the OS-specific function specification associated with the virtual device comprises an ACPI device specific method (DSM) associated with the virtual device or a custom ACPI control method associated with the virtual device.

3. The computing device of claim 1, wherein at least one of the plurality of OS-specific functions comprises an OS-specific function configured to at least one of (i) expose an OS-specific feature to the OS or (ii) expose an OS-specific object to the OS.

4. The computing device of claim 1, wherein at least one of the plurality of OS-specific functions comprises an OS-specific function configured to at least one of (i) hide an OS-specific feature from the OS or (ii) hide an OS-specific object from the OS.

5. The computing device of claim 1, wherein to transmit the call to the OS-specific function specification in the ACPI subsystem comprises to transmit the call to the OS-specific function specification in the ACPI subsystem and pass the identifier of the OS as an argument.

6. The computing device of claim 1, wherein the OS-specific function specification associated with the virtual device comprises at least one OS-specific function associated with each of a plurality of different operating systems, each OS of the plurality operating systems has a different identifier that uniquely identifies the OS from other operating systems.

7. The computing device of claim 1, wherein the OS comprises a first OS and the identifier comprises a first identifier that uniquely identifies the first OS from other operating systems;
wherein the plurality of OS-specific functions of the OS-specific function specification comprises a first group of OS-specific functions for the first OS and a second group of OS-specific functions for second OS of the computing device different from the first OS; and
wherein the first group of OS-specific functions is identified in the OS-specific function specification by the first identifier and the second group of OS-specific functions is identified in the OS-specific function specification by a second identifier different from the first identifier.

8. The computing device of claim 1, further comprising:
an ACPI driver logic to be initialized by the OS of the computing device, the ACPI driver logic to interface with the ACPI subsystem prior to initialization of the virtual device driver logic, wherein the ACPI driver logic is different from the virtual device driver logic;
wherein the ACPI subsystem is further to (i) load device data into an ACPI table associated with the ACPI subsystem, wherein the device data is indicative of the virtual device of the ACPI subsystem and the OS-specific function specification associated with the virtual device and (ii) transmit the device data from the ACPI table to the ACPI driver logic; and
wherein in response to receipt of the device data from the ACPI table by the ACPI driver logic, the OS is to enumerate the virtual device.

9. The computing device of claim 8, wherein to load the device data into the ACPI table comprises to load device data into the ACPI table from ACPI basic input/output system (BIOS) firmware of the computing device.

10. One or more machine-readable media comprising a plurality of instructions stored thereon that in response to being executed by a computing device, cause the computing device to:
initialize, by an operating system (OS) of the computing device, a virtual device driver to interface with a virtual device of an Advanced Configuration and Power Interface (ACPI) subsystem of the computing device, the ACPI subsystem comprising an OS-specific function specification associated with the virtual device, and wherein the OS-specific function specification comprising a plurality of OS-specific functions;
transmit, by the virtual device driver, a call to the OS-specific function specification in the ACPI subsystem, the call comprising an identifier of the OS that uniquely identifies the OS from other operating systems;
analyze, by the ACPI subsystem, the OS-specific function specification to determine one or more OS-specific functions of the plurality of OS-specific functions for the OS based on the identifier from the call that uniquely identifies the OS; and
perform, by the ACPI subsystem, the one or more OS-specific functions determined for the OS based on the identifier.

11. The one or more machine-readable media of claim 10, wherein the OS-specific function specification associated with the virtual device comprises an ACPI device specific method (DSM) associated with the virtual device or a custom ACPI control method associated with the virtual device.

12. The one or more machine-readable media of claim 10, wherein at least one of the plurality of OS-specific functions comprises an OS-specific function configured to at least one of (i) expose an OS-specific feature to the OS or (ii) expose an OS-specific object to the OS.

13. The one or more machine-readable media of claim 10, wherein at least one of the plurality of OS-specific functions comprises an OS-specific function configured to at least one of (i) hide an OS-specific feature from the OS or (ii) hide an OS-specific object from the OS.

14. The one or more machine-readable media of claim 10, wherein to transmit the call to the OS-specific function specification in the ACPI subsystem comprises to transmit the call to the OS-specific function specification in the ACPI subsystem and pass the identifier of the OS as an argument.

15. The one or more machine-readable media of claim 10, wherein the OS-specific function specification associated with the virtual device comprises at least one OS-specific function associated with each of a plurality of different operating systems, each OS of the plurality of operating systems has a different identifier that uniquely identifies the OS from other operating systems.

16. The one or more machine-readable media of claim 10, wherein the OS comprises a first OS and the identifier comprises a first identifier that uniquely identifies the first OS from other operating systems;
wherein the plurality of OS-specific functions of the OS-specific function specification comprises a first group of OS-specific functions for the first OS and a second group of OS-specific functions for a second OS of the computing device different from the first OS; and
wherein the first group of OS-specific functions is identified in the OS-specific function specification by the first identifier and the second group of OS-specific functions is identified in the OS-specific function specification by a second identifier different from the first identifier.

17. The one or more machine-readable media of claim 10, wherein the plurality of instructions further cause the computing device to:
load by the ACPI subsystem of the computing device, device data into an ACPI table associated with the ACPI subsystem, wherein the device data is indicative of the virtual device of the ACPI subsystem and the OS-specific function specification associated with the virtual device;
initialize, by the OS of the computing device, an ACPI driver to interface with the ACPI subsystem prior to initialization of the virtual device driver, wherein the ACPI driver is different from the virtual device driver;
transmit, by the ACPI subsystem, the device data from the ACPI table to the ACPI driver; and
enumerate, by the OS of the computing device, the virtual device in response to the ACPI driver receiving the device data from the ACPI table.

18. The one or more machine-readable media of claim 17, wherein to load the device data into the ACPI table comprises to load device data into the ACPI table from ACPI basic input/output system (BIOS) firmware of the computing device.

19. A method for selectively enabling platform-specific features on a computing device, the method comprising:
initializing, by an operating system (OS) of the computing device, a virtual device driver to interface with a virtual device of an Advanced Configuration and Power Interface (ACPI) subsystem of the computing device, the ACPI subsystem comprising an OS-specific function specification associated with the virtual device, and wherein the OS-specific function specification comprising a plurality of OS-specific functions;
transmitting, by the virtual device driver, a call to the OS-specific function specification in the ACPI subsystem, the call comprising an identifier of the OS that uniquely identifies the OS from other operating systems;
analyzing, by the ACPI subsystem, the OS-specific function specification to determine one or more OS-specific functions of the plurality of OS-specific functions for the OS based on the identifier from the call that uniquely identifies the OS; and
performing, by the ACPI subsystem, the one or more OS-specific functions determined for the OS based on the identifier.

20. The method of claim 19, wherein the OS-specific function specification associated with the virtual device comprises an ACPI device specific method (DSM) associated with the virtual device or a custom ACPI control method associated with the virtual device.

21. The method of claim 19, wherein at least one of the plurality of OS-specific functions comprises an OS-specific function configured to at least one of (i) expose an OS-specific feature to the OS or (ii) expose an OS-specific object to the OS.

22. The method of claim 19, wherein at least one of the plurality of OS-specific functions comprises an OS-specific function configured to at least one of (i) hide an OS-specific feature from the OS or (ii) hide an OS-specific object from the OS.

23. The method of claim 19, wherein transmitting the call to the OS-specific function specification in the ACPI subsystem comprises transmitting the call to the OS-specific function specification in the ACPI subsystem and passing the identifier of the OS as an argument.

24. The method of claim 19, wherein the OS-specific function specification associated with the virtual device comprises at least one OS-specific function associated with each of a plurality of different operating systems, each OS of the plurality of operating systems having a different identifier that uniquely identifies the OS from other operating systems.

25. The method of claim 19, wherein the OS comprises a first OS and the identifier comprises a first identifier that uniquely identifies the first OS from other operating systems;
wherein the plurality of OS-specific functions of the OS-specific function specification comprises a first group of OS-specific functions for the first OS and a second group of OS-specific functions for a second OS of the computing device different from the first OS; and
wherein the first group of OS-specific functions is identified in the OS-specific function specification by the first identifier and the second group of OS-specific functions is identified in the OS-specific function specification by a second identifier different from the first identifier.
